(19) United States
(12) Patent Application Publication
(10) Pub. No.: US 2012/0163595 A1
(43) Pub. Date: Jun. 28, 2012

(54) METHOD AND SYSTEM FOR PROVIDING LAYERED ACCESS CONTROL FOR SCALABLE MEDIA

(75) Inventors: Hyeok Chan KWON, Daejeon (KR); Taek Yong NAM, Daejeon (KR); Seungmin LEE, Daejeon (KR); Dae-Hee SEO, Daejeon (KR); Yong Hyuk MOON, Daejeon (KR); Jae Hoon NAH, Daejeon (KR); Dong il SEO, Daejeon (KR)

(73) Assignee: Electronics and Telecommunications Research Institute, Daejeon (KR)

(21) Appl. No.: 13/329,492

(22) Filed: Dec. 19, 2011

(30) Foreign Application Priority Data
Dec. 22, 2010 (KR) 10-2010-0132078

(51) Int. Cl. H04N 7/167

(52) U.S. Cl. 380/201

(57) ABSTRACT

An encryption method for providing layered access control for scalable media includes encrypting the scalable media using different encryption keys for respective layers of the scalable media to create a protected content; providing the protected content to a first user terminal; selectively inserting part or all of the encryption keys into a key area of a right object based on the grade of the first user terminal to generate a first right object; and providing the first right object to the first user terminal.

### CROSS-REFERENCE TO RELATED APPLICATION(S)

The present invention claims priority of Korean Patent Application No. 10-2010-0132078, filed on Dec. 22, 2010, which is incorporated herein by reference.

### FIELD OF THE INVENTION

The present invention relates generally to Digital Rights Management (DRM) technology for multimedia data and, more particularly, to a system and method for providing layered access control for scalable media that is encoded using a Scalable Video Coding (SVC).

### BACKGROUND OF THE INVENTION

As is well known to those skilled in the art, scalable media is media that has been encoded using a Scalable Video Coding (SVC). The scalable media are characterized by a hierarchical coding in which all codecs are configured for individual layers, only the required layers are extracted to enable a media service corresponding to the desired level to be provided. The layers of SVC are composed of a single base layer, and one or more enhancement layers that can be continuously stacked on the base layer. Each enhancement layer can represent the maximum bit rate, frame rate and spatial resolution that are given to the enhancement layer on the basis of information about a lower layer. In SVC, as a larger number of enhancement layers are continuously layered, various bit rates, frame rates and resolutions can be supported.

In the present specification, a base layer is represented by a layer 1, and enhancement layers are represented by layers 2, 3, 4, etc. for the sake of description. Taking the resolution as an example, a layer 1 configures a low-resolution codec, a combination of layers 1 and 2 configure a medium-resolution codec, and a combination of layers 1, 2, and 3 configure a high-resolution codec.

FIG. 1 shows a diagram of a typical scalable media-based service system, in which layers are configured based on resolution.

An SVC encoder 101 generates scalable media of bit streams. In FIG. 1, for example, the scalable media are composed of three layers, a layer 1, layer 2 and layer 3.

An extractor 102 that received the scalable media functions to extract only a required bit stream suitable for the characteristics of a target device and transmit the bit stream to the target device. In FIG. 1, High Definition Television (HDTV) 103 of high-resolution, a Personal Computer (PC) 104 of medium-resolution, and a Personal Digital Assistant (PDA) 105 of low-resolution are given as examples of devices.

All of layers 1, 2 and 3 are transmitted to the high-resolution HDTV 103, layers 1 and 2 are transmitted to the medium-resolution PC 104, and layer 3 is truncated. Only layer 1 is transmitted to the low-resolution PDA 105 and layers 2 and 3 are truncated.

Such a scalable media-based service is advantageous in that it supports One Source Multi Use (OSMU) enabling the service to be provided to user's devices under different conditions such as different network bandwidths, device performances, and displays using only a video which has been encoded once.

Meanwhile, DRM, which is a technology for managing the copyrights of digital works, not only allows just a user having a right to use the digital works to have access thereto, but also enables usage methods, the number of uses, a usage period, etc. to be limited depending on permission information, condition information, etc.

The structures of DRM and the names of respective objects slightly differ amongst themselves depending on various DRM standards and commercial products, but the basic structures and operating methods thereof are almost identical to one another. From a conceptual standpoint, an introduction to DRM is as follows.

FIG. 2 is a diagram showing a conventional DRM service system.

A content issuer 201 functions to encrypt and distribute contents, and is configured to create a protected content 204 and distribute the protected content 204 to a first user terminal 207 on which a first DRM agent 203 is mounted.

The first user terminal 207 may transfer the protected content 204 to a second user terminal 208 on which a second DRM agent 206 is mounted.

A rights issuer 202 functions to generate a right object 205 including permission information, condition information, and a content decryption key, which are related to the protected content, and sell the right object 205 to the users of the first and second terminal 207 and 208.

Sensitive information within the right object 205 is encrypted.

The first and second DRM agents 203 and 206 are client modules which accesses the rights issuer 202 to acquire the right object 205 so as to use the protected content 204. The first and second DRM agents 203 and 206 use the protected content in conformity with given conditions on the basis of the right object 205. Generally, the acquisition of the right object 205 is performed by a procedure of purchasing the protected content. In this connection, since a method of performing authentication between the DRM agents 203 and 206 (or the user terminals 207 and 208) and the rights issuer 202 does not directly pertain to the present invention, a detailed description thereof is omitted.

The protected content 204 may be copied or moved between user terminals, but a user terminal that received the protected content 204 can use the content only when purchasing the right object 205.

FIG. 3 illustrates the format of the protected content 204 of FIG. 2.

Identifier 301 includes the identification (ID) of the content.

Metadata 302 includes an encryption scheme, the Uniform Resource Locator (URL) of a rights issuer, information about a content provider, etc.

Encrypted content 303 denotes encrypted data.

Digital signature 304 denotes a signature made using the private key of a content provider, and is used to verify the content provider and integrity.

FIG. 4 illustrates the format of the right object 205 of FIG. 2.

A key 401 presents a key used for the encryption of content, and generally includes the following keys although there may be a difference between DRM products.

Master key: a master key may be configured using different schemes in accordance with the application of DRM, and is used to encrypt a Right Encryption Key (REK).

Right encryption key: this key is used to encrypt Content Encryption Key (CEK).

Content encryption key: this key is used to encrypt contents.

ID 402 includes the ID of a rights issuer, the ID of the contents, etc.

Permission 403 is information required to limit the methods of using content, and contains permission information such as information about playing, viewing, printing, copying, moving, editing, extracting, and embedding contents.

Condition 404 is information used to define the conditions of the use of contents, and includes a usage period of content, a content usage count of content (the number of uses of the content), a trace of content (the monitoring of usage details of a content user), a domain of content (the limitation of the use of content to a specific user, a specific group or a specific region), etc.

However, the conventional DRM service is problematic in that layered access control for scalable media cannot be supported.

### SUMMARY OF THE INVENTION

In view of the above, the present invention provides a system and method for providing layered access control for scalable media.

In accordance with a first aspect of the present invention, there is provided an encryption method for providing layered access control for scalable media for use in a service provider that encrypts the scalable media, the encryption method including:

encrypting the scalable media using different encryption keys for respective layers of the scalable media to create a protected content;

providing the protected content to a first user terminal;

selectively inserting part or all of the encryption keys into a key area of a right object based on the grade of the first user terminal to generate a first right object; and

providing the first right object to the first user terminal.

In accordance with a second aspect of the present invention, there is provided a decryption method for providing layered access control for scalable media for use in user terminals that decrypt the scalable media, the decryption method including:

receiving, at a first user terminal, a protected content which is created by encrypting a scalable media using different encryption keys for respective layers of the scalable media;

receiving, at the first user terminal, a first right object which is generated by selectively inserting part or all of the encryption keys of the protected content into a key area of a right object based on the grade of the first user terminal; and

decrypting, at the first user terminal, some layers of the protected content using encryption keys included in a key area of the first right object.

In accordance with a third aspect of the present invention, there is provided an encryption method for providing layered access control for scalable media for use in a service provider that encrypts the scalable media, the encryption method including:

encrypting the scalable media using an identical encryption key without a distinction between layers of the scalable media to create a protected content;

providing the protected content to a first user terminal;

inserting information about some of accessible layers of the layers of the scalable media into a layer field of a condition area of the right object based on the grade of the first user terminal to generate a first right object; and

providing the first right object to the first user terminal.

In accordance with a fourth aspect of the present invention, there is provided a decryption method for providing layered access control for scalable media for use in user terminals that decrypt the scalable media, the decryption method comprising:

receiving, at the first user terminal, a protected content which is created by encrypting the scalable media using an identical key without a distinction between layers of the scalable media;

receiving, at the first user terminal, a first right object which is generated by inserting information about some of accessible layers of the layers of scalable media into a layer field of a condition area of a right object based on the grade of the first user terminal;

acquiring, at the first user terminal, an encryption key included in a key area of the first right object to check the information about some of the accessible layers stored in the layer field of the condition area; and

decrypting, at the first user terminal, some layers of the protected content while filtering out remaining layers depending on the information about some of the accessible layers.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram of a typical scalable media-based service system, in which layers are configured based on resolution;

FIG. 2 is a diagram showing a conventional DRM service system;

FIG. 3 illustrates the format of the protected content 204 of FIG. 2;

FIG. 4 illustrates the format of the right object 205 of FIG. 2;

FIG. 5 is a diagram of a system for DRM providing layered access control for scalable media in accordance with a first embodiment of the present invention;

FIG. 6 is a diagram showing a process for changing a right to layered access control in the embodiment of FIG. 5;

FIG. 7 is a diagram of a system for DRM providing layered access control for scalable media in accordance with a second embodiment of the present invention; and

FIG. 8 is a diagram showing a process for changing a right to layered access control in the embodiment of FIG. 7.

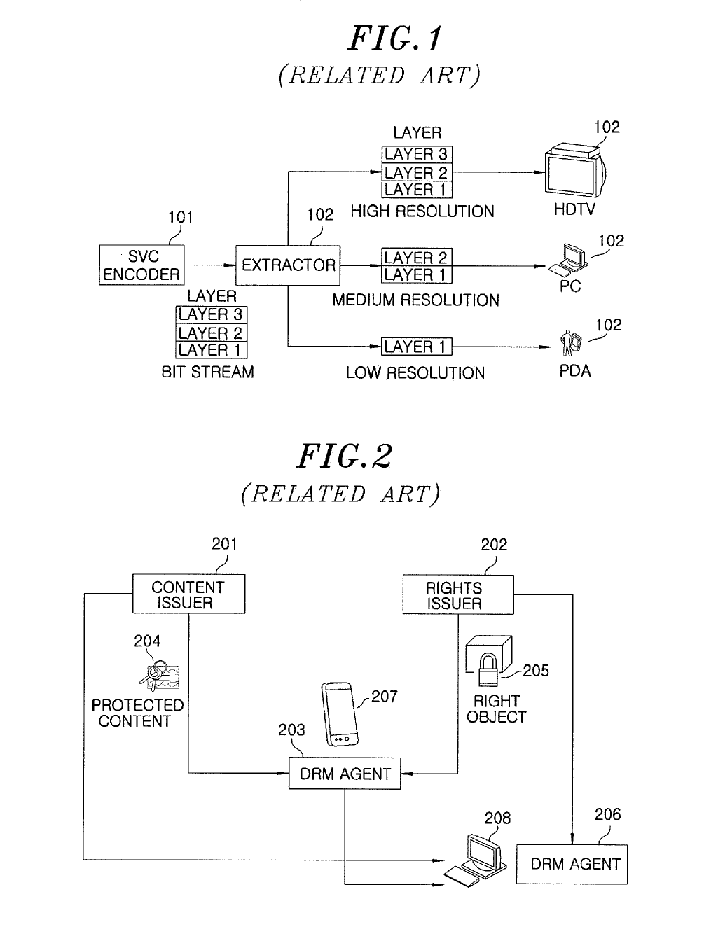

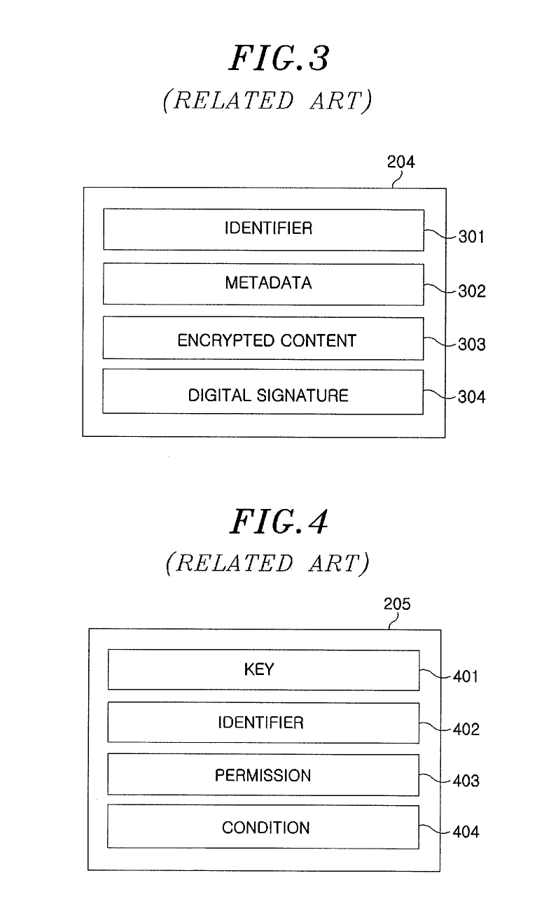

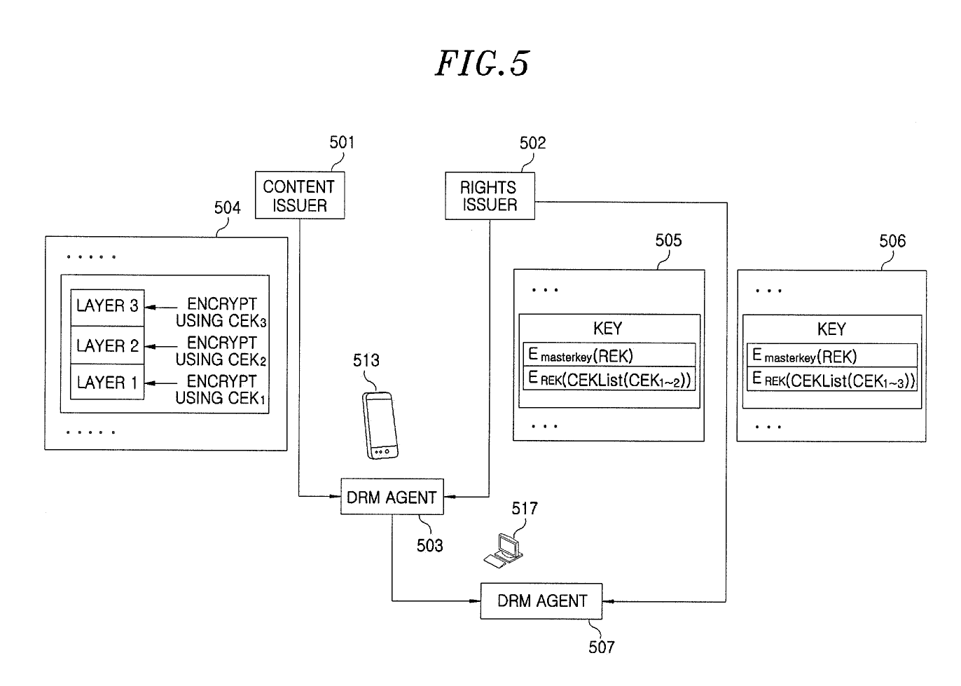

### DETAILED DESCRIPTION OF THE PREFERRED EMBODIMENTS

Hereinafter, embodiments of the present invention will be described in detail with reference to the accompanying drawings so that they can be readily implemented by those skilled in the art.

Before explaining the embodiments of the present invention, may be considered that a content issuer, a rights issuer, and a Digital Rights Management (DRM) agent described in the overall specification of the present invention denote server devices, user terminals, or application programs, which provide relevant functions or services. Further, a content issuer and a rights issuer may be commonly designated as a service provider, which can also denote a server device, a terminal device or an application program that provides a content provision service.

FIG. 5 is a diagram of a system for DRM providing layered access control for scalable media in accordance with a first embodiment of the present invention.

The embodiment of FIG. 5 relates to a digital rights protection method of providing layered access control for scalable media using the hierarchical key management by a rights issuer and the layered differential encryption by a content issuer. This embodiment describes a scheme configured such that the content issuer encrypts the respective layers of scalable media using different keys and such that the rights issuer provides some of whole encryption keys in accordance with the right of a user.

First, a content issuer 501 encrypts, e.g., a video of scalable media using different keys for respective layers of the scalable media to create a protected content 504. Further, the content issuer 501 registers a set of keys, Content Encryption Keys (CEKs), used to encrypt the content in a rights issuer 502. In FIG. 5, three keys are used and a set of the three keys is indicated by CEK₁ to CEK₃.

The content issuer 501 transfers the protected content 504 to a first DRM agent 503 mounted on a first user terminal 513.

In order to use the content, the first DRM agent 503 accesses the rights issuer 502 and then acquires a first right object 505. For example, the first DRM agent 503 may be issued with the right object 505 after paying for content.

The rights issuer 502 generates the first right object 505 by inserting a content encryption key into the key area of the first right object in accordance with the grade of the user, and transfers the first right object 505 to the first DRM agent 503. For example, the grade of the user may be determined based on, e.g., an amount of fees paid by the user. FIG. 5 shows that the content encryption key includes up to CEK₁ and CEK₂ in conformity with the grade of the user. For example, a list of CEKs (CEKList) may be encrypted using a Right Encryption Key (EREK), and the REK may be encrypted using a master key (Emasterkey).

The first DRM agent 503 that received the first right object 505 acquires the content encryption keys CEK₁ and CEK₂ included in the key area, and decrypts up to layers 1 and 2 of the encrypted content for the protected content 504 based on the content encryption keys CEK₁ and CEK₂. Thereafter, the DRM agent 503 combines the decrypted layers 1 and 2 with each other, decodes the combined results, and transfers the decoded results to the first user terminal 513 having a content player.

Meanwhile, the protected content 504 may be copied or moved from the first user terminal 513 on which the first DRM agent 503 is mounted to another user terminal.

With reference to FIG. 5, a description will be made the case where the first DRM agent 503 transfers the protected content 504 to a second DRM agent 507 mounted on the second user terminal 517.

In order to move the protected content 504, the second DRM agent 507 in the second user terminal 517 accesses the rights issuer 502 and then acquires a second right object 506.

The rights issuer 502 generates the second right object 506 by inserting a content encryption key into the key area of the right object in accordance with the grade determined based on, for example, an amount of fees paid by a user of the second terminal 517, and transfers the second right object 506 to the second DRM agent 507. In FIG. 5, the content encryption key is shown as including up to CEK₁ to CEK₃ in conformity with the grade of the user. The second DRM agent 507 that received the second right object 506 acquires the content encryption keys CEK₁ to CEK₃ included in the key area, and decrypts the layers 1 to 3 for the encrypted content of the protected content 504. Thereafter, the second DRM agent 507 combines the decrypted results, decodes the combined results, and transfers the decoded results to the second user terminal 517 having a content player.

For example, if it is assumed that the layers 1 and 2 are videos encoded to enable SD-level playing and the layers 1 to 3 are videos encoded to enable HD-level playing, the first DRM agent 503 and the second DRM agent 507 that received the same protected content can play SD-level videos and HD-level videos, respectively, depending on the grades of the users who own the first and the second terminals 513 and 517.

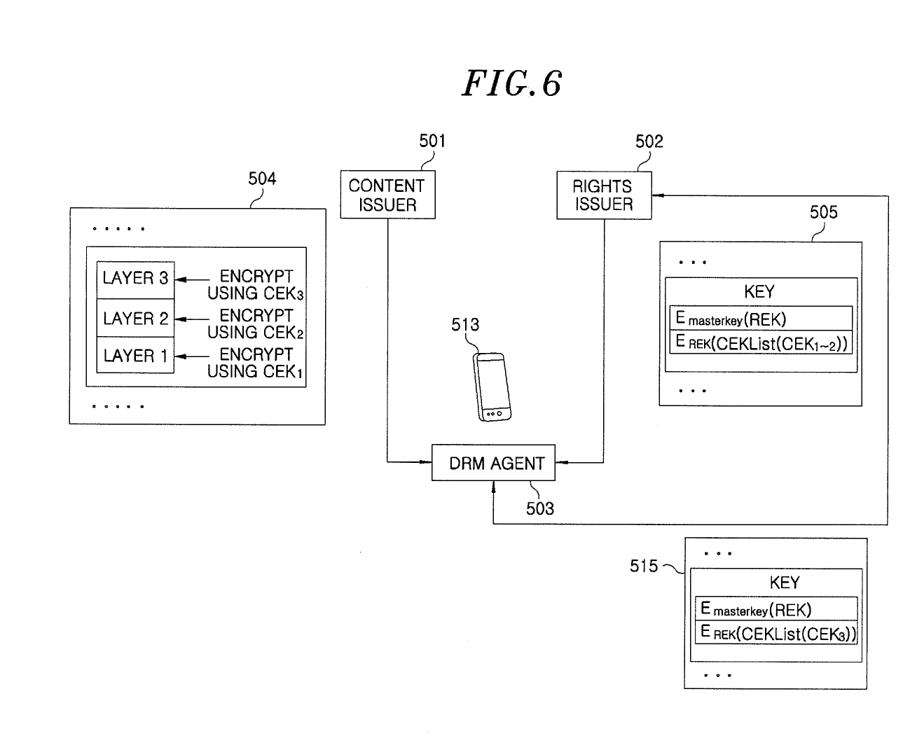

Meanwhile, in order for the first DRM agent 503 to view an upper level of high-quality videos combined up to layer 3, the first DRM agent 503 may request an additional right to layer 3 from the rights issuer 502. This embodiment is separately shown in FIG. 6.

Referring to FIG. 6, in order to view high-quality videos combined up to layer 3, the DRM agent 503 mounted on the user terminal 513 makes a request for an additional right to layer 3 from the rights issuer 502.

The rights issuer 502 checks the grade of a user who owns the terminal 513 so as to provide an additional right to the layer 3. After that, the rights issuer 502 inserts an additional content encryption key CEK₃ for the requested layer into the key area of the first right object 505 to generate a second right object 515, and transfers the right object 515 to the DRM agent 503. For example, the grade of the user may be determined based on an amount of fees paid by the user.

The DRM agent 503 that received the right object 515 acquires the content encryption key CEK₃ included in the key area of the second right object 515, decrypts up to the layers 1 to 3 of the encrypted content for the protected content 504 using the CEK₃, and CEK₁ and CEK₂ which have been previously acquired from the first right object 505. Thereafter, the DRM agent 503 combines the decrypted results, decodes the combined results, and transfers the decoded results to the user terminal 513.

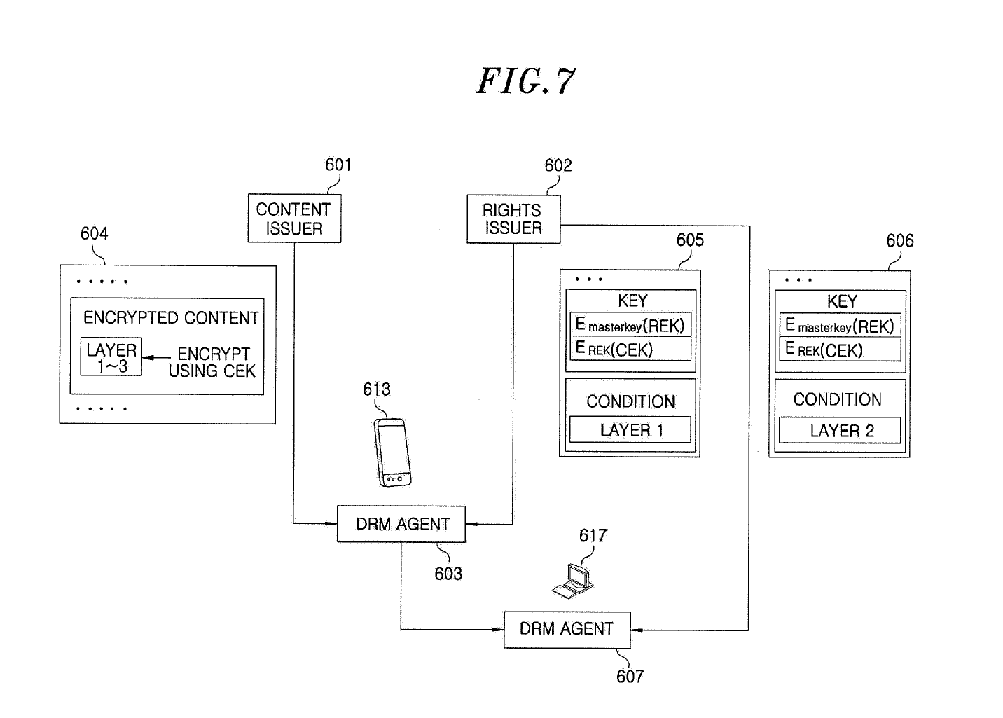

FIG. 7 is a diagram of a system for DRM providing layered access control for scalable media in accordance with a second embodiment of the present invention.

The embodiment of FIG. 7 relates to a digital right protection method for adding the requirement of condition information of layers to right objects, performing filtering in a DRM agent based on the condition information, and providing layered access control for scalable media. This embodiment describes a scheme in which a content issuer performs encryption using the same key regardless of the configuration of the layers of scalable media, and in which a rights issuer inserts access control information to the layer into a condition information area within a right object in conformity with the right of a user.

First, a content issuer 601 encrypts the video of scalable media using the same key without a distinction between layers of the video to generate a protected content 604. Further, the content issuer 601 registers the key used for encryption of the content in a rights issuer 602. The key used for encryption is indicated by “CEK” in FIG. 6 The content issuer 601 transfers the protected content 604 to a first DRM agent 603 mounted on a first user terminal 613.

In order to use the content, the first DRM agent 603 accesses the rights issuer 602 and then acquires a first right object 605. For example, the first DRM agent 603 may be issued with the right object 605 after paying for the content.

The rights issuer 602 inserts information about an uppermost accessible layer(s) to which the DRM agent is uppermost accessible into the layer field of condition area of a right object in accordance with the grade of the user terminal (customer) to complete a first right object 605, and provides the first right object 605 to the first DRM agent 603. For example, the grade of the user may be determined based on fees paid by the user who owns the first terminal 613. In the embodiment of FIG. 7, a value inserted into the layer field is shown as being ‘layer 1.’

The first DRM agent 603 that received the first right object 605 acquires the content encryption key CEK included in the key area, and then checks the information stored in the layer field of the condition area. In the embodiment of FIG. 7, since the information stored in the layer field is ‘layer 1’, the first DRM agent 603 decrypts only the layer 1 of the encrypted content 604 and filters out data corresponding to layers higher than the layer 1. For example, data filtering methods may differ depending on the application programs of the first DRM agent 603, and schemes of limiting the use of a content encryption key may be used when the lifetime of the content encryption key has expired or when the number of uses of content has been exceeded.

The first DRM agent 603 then transfers the filtered and decrypted content to a player such as the content player of the user terminal 613, and can play the video decoded using only the layer 1 in the embodiment of FIG. 7.

Meanwhile, the protected content 604 may be copied or moved from the first user terminal 613 on which the first DRM agent 603 is mounted to another user terminal.

With reference to FIG. 7, a description will be made the case where the first DRM agent 603 transfers the protected content 604 to a second DRM agent 607 mounted on the second user terminal.

In order to move the protected content 504, the first DRM agent 603 transfers the protected content 604, which it received, to the second DRM agent 607 mounted on another user terminal 617.

The second DRM agent 607 accesses the rights issuer 602 and then acquires a right object.

The rights issuer 602 inserts information about an accessible uppermost layer(s) into the layer field of the condition area of a right object in accordance with the grade of the user to complete a second right object 606, and transfers the second right object 606 to the second DRM agent 607. For example, the grade of the user may be determined based on fees paid by the user. In the embodiment of FIG. 7, a value inserted into the layer field is shown as being ‘layer 2.’

The second DRM agent 607 that received the second right object 606 acquires a content encryption key CEK included in the key area of the received right object, and then checks information stored in the layer field of the condition area. In the embodiment of FIG. 7, since the information stored in the layer field is ‘layer 2’, the second DRM agent 607 combines and decrypts up to layers 1 and 2 of the encrypted content 604, and filters out data corresponding to layers higher than layer 2.

The second DRM agent 607 then transfers the filtered and decrypted content to a player such as a content player. In the embodiment of FIG. 7, the video decoded using a combination of layers 1 and 2 can be played.

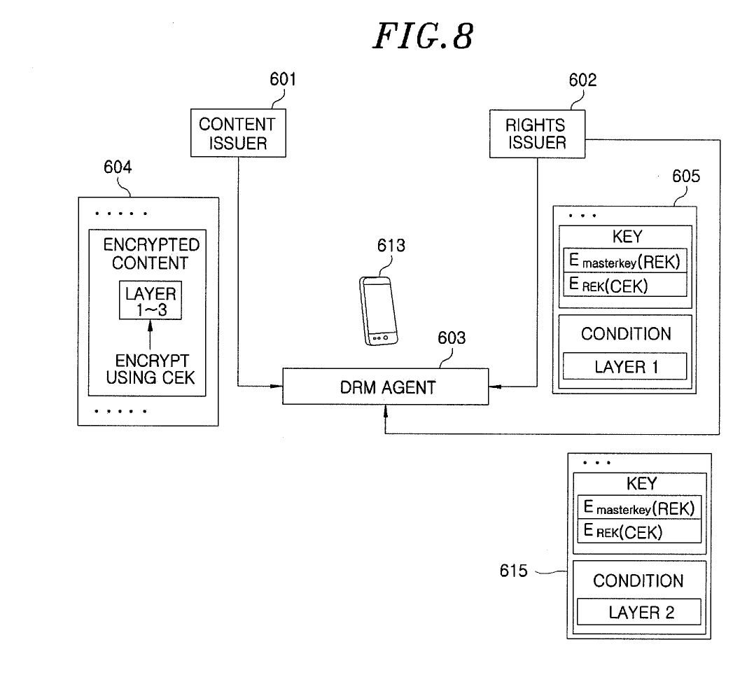

Meanwhile, in order for the first DRM agent 603 to view upper level of high-quality videos combined up to layer 2, the first DRM agent 603 may request an additional right to layer 2 from the rights issuer 602. This embodiment is separately shown in FIG. 8.

Referring to FIG. 8, in order for the DRM agent 603 to view videos of video quality, combined up to layer 2, the DRM agent 603 requests an additional right to layer 2 from the rights issuer 602.

The rights issuer 602 checks the grade of a user who owns the terminal 613 so as to provide an additional right to layer 2. After that, the right issuers 602 inserts information about an accessible uppermost layer(s) into the layer field of the condition area of the right object 605 to complete a second right object 606. For example, the grade of the user may be determined based on fees paid by the user. In the embodiment of FIG. 8, the case where a value inserted into the layer field is shown as being ‘layer 2.’

The rights issuer 602 then transfers the second right object 606 to the DRM agent 603.

The DRM agent 603 that received the second right object 606 acquires a content encryption key CEK included in the key area, and then checks the information stored in the layer field of the condition area. In the embodiment of FIG. 8, since the information stored in the layer field of the new right object 606 is ‘layer 2’, the DRM agent 603 combines and decrypts up to layers 1 and 2 of the encrypted content, and filters out data corresponding to layers higher than layer 2. In this case, as the encrypted content, the protected content 604 previously received from the content issuer 601 can be used without change. For example, in FIG. 7, the protected content 604 received from the content issuer 601 can be used without change.

The DRM agent 603 then transfers the filtered and decrypted content to a player such as the content player. In the embodiment of FIG. 8, the DRM agent 603 can play the video decoded using a combination of layers 1 and 2.

As described above, since layered access control can be performed depending on right objects acquired by respective users even if protected scalable media content is equally distributed in accordance with an embodiment of the present invention, the OSMU of DRM can be supported. For example, the same encrypted content is distributed to various users, and video quality can be controlled in such a way that SD level or HD level videos can be viewed depending on right objects acquired by the respective users. Further, it is possible to view HD-level videos by paying an additional fee and acquiring an additional right object while viewing SD-level videos. Furthermore, the present invention can provide the same content to customers depending on the grades of the customers and can also provide different services to those customers.

While the invention has been shown and described with respect to the preferred embodiments, it will be understood by those skilled in the art that various changes and modifications may be made without departing from the spirit and scope of the invention as defined in the following claims.

What is claimed is:

1. An encryption method for providing layered access control for scalable media for use in a service provider that encrypts the scalable media, the encryption method comprising:
encrypting the scalable media using different encryption keys for respective layers of the scalable media to create a protected content;
providing the protected content to a first user terminal;
selectively inserting part or all of the encryption keys into a key area of a right object based on the grade of the first user terminal to generate a first right object; and
providing the first right object to the first user terminal.

2. The encryption method of claim 1, further comprising:
moving the protected content from the first user terminal to a second user terminal,
said moving the protected content includes:
selectively inserting part or all of the encryption keys into the key area of the right object based on the grade of the second user terminal to generate a second right object; and
providing the second right object to the second user terminal.

3. The encryption method of claim 1, further comprising:
in response to a request for an additional right to another layer from the first user terminal, providing the first right object having the additional right to the first user terminal,
said providing the first right object having the additional right to the first user terminal includes:
additionally inserting part or all of the encryption keys for the another layer into the key area of the first right object in response to the request of the first user terminal to generate the first right object having the additional right; and
transferring the first right object having the additional right to the first user terminal.

4. A decryption method for providing layered access control for scalable media for use in user terminals that decrypt the scalable media, the decryption method comprising:
receiving, at a first user terminal, a protected content which is created by encrypting a scalable media using different encryption keys for respective layers of the scalable media;
receiving, at the first user terminal, a first right object which is generated by selectively inserting part or all of the encryption keys of the protected content into a key area of a right object based on the grade of the first user terminal; and
decrypting, at the first user terminal, some layers of the protected content using encryption keys included in a key area of the first right object.

5. The description method of claim 4, further comprising:
moving the protected content from the first user terminal to a second user terminal,
said moving the protected content includes:
receiving, at the second user terminal, the protected content from the first user terminal;
receiving, at the second user terminal, a second right object which is generated by inserting part or all of the encryption keys into the key area of the right object based on the grade of the second user terminal; and
decrypting, at the second user terminal, some or all of layers of the protected content using encryption keys included in a key area of the second right object.

6. The decryption method of claim 4, further comprising:
in response to a request for an additional right to another layer from the first user terminal, providing the first right object having the additional right to the first user terminal,
said providing the first right object having the additional right to the first user terminal includes:
receiving the first right object having the additional right which is generated by additionally inserting part or all of the encryption keys into the key area of the first right object; and
decrypting some or all of layers of the protected content using encryption keys included in a key area of the first right object having the additional right at the first user terminal.

7. An encryption method for providing layered access control for scalable media for use in a service provider that encrypts the scalable media, the encryption method comprising:
encrypting the scalable media using an identical encryption key without a distinction between layers of the scalable media to create a protected content;
providing the protected content to a first user terminal;
inserting information about some of accessible layers of the layers of the scalable media into a layer field of a condition area of the right object based on the grade of the first user terminal to generate a first right object; and
providing the first right object to the first user terminal.

8. The encryption method of claim 7, further comprising:
moving the protected content from the first user terminal to a second user terminal,
said moving the protected content includes:
additionally inserting information about some or all of accessible layers of the layers of the scalable media into the layer field of the condition area of the right object based on the grade of the second user terminal to generate a second right object; and
providing the second right object to the second user terminal.

9. The encryption method of claim 7, further comprising:
in response to a request for an additional right to another layer from the first user terminal, providing the first right object having the additional right to the first user terminal,
said providing the first right object having the additional right to the first user terminal includes:
additionally inserting information about some or all of accessible layers of the layers of the scalable media into the layer field of the condition area of the first right object to generate the first right object having the additional right; and
transferring the first right object having the additional right to the first user terminal.

10. A decryption method for providing layered access control for scalable media for use in user terminals that decrypt the scalable media, the decryption method comprising:
receiving, at the first user terminal, a protected content which is created by encrypting the scalable media using an identical key without a distinction between layers of the scalable media;
receiving, at the first user terminal, a first right object which is generated by inserting information about some of accessible layers of the layers of scalable media into a layer field of a condition area of a right object based on the grade of the first user terminal;
acquiring, at the first user terminal, an encryption key included in a key area of the first right object to check the information about some of the accessible layers stored in the layer field of the condition area; and
decrypting, at the first user terminal, some layers of the protected content while filtering out remaining layers depending on the information about some of the accessible layers.

11. The decryption method of claim 10, further comprising:
moving the protected content from the first user terminal to a second user terminal,
said moving the protected content includes:
receiving, at the second user terminal, the protected content from the first user terminal;
receiving, at the second user terminal, a second right object which is generated by additionally inserting information about some or all of accessible layers of the layers of the scalable media into the layer field of the condition area of the right object based on the grade of the second user terminal;
acquiring, at the second user terminal, an encryption key included in a key area of the second right object to check information about some or all of the accessible layers stored in the layer field of the condition area; and
selectively decrypting, at the second user terminal, some layers of the protected content while filtering out remaining layers, depending on information about some or all of the accessible layers.

12. The decryption method of claim 10, further comprising:
in response to a request for an additional right to another layer from the first user terminal, providing the first right object having the additional right to the first user terminal,
said providing the first right object having the additional right to the first user terminal includes:
receiving, at the first user terminal, the first right object having the additional right which is generated by additionally inserting information about some or all of the accessible layers of the layers of scalable media into the layer field of the condition area of the first right object;
acquiring, at the first user terminal, the encryption key included in a key area of the first right object to check information about some or all of the accessible layers stored in the layer field of the condition area; and
decrypting, at the first user terminal, some layers of the protected content while filtering out remaining layers, depending on the information about some or all of the accessible layers.
